(19) United States
(12) Patent Application Publication
(10) Pub. No.: US 2020/0031624 A1
(43) Pub. Date: Jan. 30, 2020

(54) ELEVATOR TENSION MEMBER VERIFICATION

(71) Applicant: Otis Elevator Company, Farmington, CT (US)

(72) Inventors: Kyle B. Martin, Avon, CT (US); Randall S. Dube, Glastonbury, CT (US)

(21) Appl. No.: 16/046,209

(22) Filed: Jul. 26, 2018

(51) Int. Cl. B66B 7/12; B66B 1/28; B66B 3/00

(52) U.S. Cl. CPC B66B 7/1238; B66B 3/00; B66B 1/28

(57) ABSTRACT

A tension member verification system of an elevator system includes one or more identifier elements located at the tension member. The one or more identifier elements include one or more configuration parameters of the tension member. A detector is positioned and configured to verify presence of the one or more identifier elements, and is configured to read the one or more configuration parameters of the tension member. An elevator system controller is operably connected to the detector and is configured to compare the detected one or more configuration parameters to stored configuration parameters stored at the elevator system controller, and take one or more actions in operation of the elevator system based on the result of the comparison.

### BACKGROUND

Exemplary embodiments pertain to the art of elevator systems. More particularly, the present disclosure relates to verification or authentication of tension members of elevator systems.

Elevator systems utilize one or more tension members operably connected to an elevator car and a counterweight in combination with, for example, a machine and traction sheave, to suspend and drive the elevator car along a hoistway. In some systems, the tension member is a belt having one or more tension elements retained in a jacket. The tension elements may be formed from, for example, steel wires or other materials, such as a carbon fiber composite. The tension elements support the load and the jacket holds the tension elements and transfers shear forces to the traction sheave.

When operating an elevator system, it is imperative that the proper tension members are installed, such that the tension members will meet performance standards and requirements for the elevator system.

### BRIEF DESCRIPTION

In one embodiment, a tension member verification system of an elevator system includes one or more identifier elements located at the tension member. The one or more identifier elements include one or more configuration parameters of the tension member. A detector is positioned and configured to verify presence of the one or more identifier elements, and is configured to read the one or more configuration parameters of the tension member. An elevator system controller is operably connected to the detector and is configured to compare the detected one or more configuration parameters to stored configuration parameters stored at the elevator system controller, and take one or more actions in operation of the elevator system based on the result of the comparison.

Additionally or alternatively, in this or other embodiments the one or more identifier elements are one or more of a bar code or an RFID tag.

Additionally or alternatively, in this or other embodiments the one or more configuration parameters include one or more of manufacturer, date of manufacture or time of manufacture.

Additionally or alternatively, in this or other embodiments the one or more actions include one or more of sounding an alarm or slowing operation of the elevator system to below a normal operating speed.

Additionally or alternatively, in this or other embodiments the controller is configured to take the one or more actions when a result of the comparison indicates that an incorrect tension member is installed in the elevator system.

Additionally or alternatively, in this or other embodiments the detector is fixed in a hoistway of the elevator system.

In another embodiment, an elevator system includes a hoistway, an elevator car movable along the hoistway, one or more tension members operably connected to the elevator car to move the elevator car along the hoistway, and a tension member verification system. The tension member verification system includes one or more identifier elements located at the tension member. The one or more identifier elements include one or more configuration parameters of the tension member. A detector is positioned and configured to verify presence of the one or more identifier elements, and configured to read the one or more configuration parameters of the tension member. An elevator system controller is operably connected to the detector and is configured to compare the detected one or more configuration parameters to stored configuration parameters stored at the elevator system controller, and take one or more actions in operation of the elevator system based on the result of the comparison.

Additionally or alternatively, in this or other embodiments the one or more identifier elements are one or more of a bar code or an RFID tag.

Additionally or alternatively, in this or other embodiments the one or more configuration parameters include one or more of manufacturer, date of manufacture or time of manufacture.

Additionally or alternatively, in this or other embodiments the one or more actions include one or more of sounding an alarm or slowing operation of the elevator system to below a normal operating speed.

Additionally or alternatively, in this or other embodiments the controller is configured to take the one or more actions when a result of the comparison indicates that an incorrect tension member is installed in the elevator system.

Additionally or alternatively, in this or other embodiments the detector is fixed in the hoistway.

In yet another embodiment, a method of verification of a tension member of an elevator system includes storing one or more configuration parameters of a correct tension member of an elevator system at an elevator system controller, detecting an identifier element of an installed tension member of the elevator system via a detector. transmitting a detected one or more configuration parameters of the installed tension member to the elevator system controller via the detector, comparing the one or more configuration parameters of the installed tension member to the one or more configuration parameters of the correct tension member at the elevator system controller, and taking one or more actions in operation of the elevator system via the elevator system controller based on a result of the comparison.

Additionally or alternatively, in this or other embodiments the method includes one or more of sounding an alarm or slowing operation of the elevator system to a speed below normal operating speed based on the result of the comparison.

Additionally or alternatively, in this or other embodiments the operation of the elevator system is slowed to a speed of about 0.5 m/s.

Additionally or alternatively, in this or other embodiments the result of the comparison indicates that an incorrect tension member is installed in the elevator system.

Additionally or alternatively, in this or other embodiments the one or more identifier elements are one or more of a bar code or an RFID tag.

Additionally or alternatively, in this or other embodiments the one or more configuration parameters include one or more of manufacturer, date of manufacture or time of manufacture.

Additionally or alternatively, in this or other embodiments the detector is fixed in the hoistway.

### BRIEF DESCRIPTION OF THE DRAWINGS

The following descriptions should not be considered limiting in any way. With reference to the accompanying drawings, like elements are numbered alike:

FIG. 1 is a schematic illustration of an elevator system;

FIG. 2 is a cross-sectional view of an embodiment of an elevator system belt;

FIG. 2A is another cross-sectional view of an embodiment of an elevator system belt;

FIG. 3A is a cross-sectional view of an embodiment of a tension member for an elevator belt;

FIG. 3B is another cross-sectional view of an embodiment of a tension member for an elevator belt;

FIG. 4 is a schematic view of a tension member verification system for an elevator system; and

FIG. 5 is schematic view of a method of operating a tension member verification system.

### DETAILED DESCRIPTION

A detailed description of one or more embodiments of the disclosed apparatus and method are presented herein by way of exemplification and not limitation with reference to the Figures.

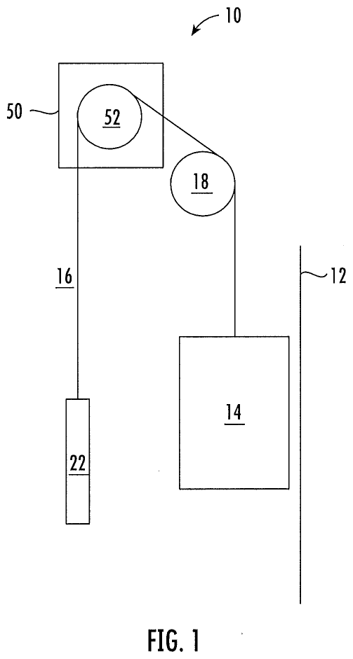

Shown in FIG. 1 is a schematic view of an exemplary traction elevator system 10. Features of the elevator system 10 that are not required for an understanding of the present invention (such as the guide rails, safeties, etc.) are not discussed herein. The elevator system 10 includes an elevator car 14 operatively suspended or supported in a hoistway 12 with one or more tension members, for example belts 16. While the following description, belts 16 are the tension members utilized in the elevator system 10, one skilled in the art will readily appreciate that the present disclosure may be utilized with other tension members, such as ropes. The one or more belts 16 interact with sheaves 18 and 52 to be routed around various components of the elevator system 10. Sheave 18 is configured as a diverter, deflector or idler sheave and sheave 52 is configured as a traction sheave, driven by a machine 50. Movement of the traction sheave 52 by the machine 50 drives, moves and/or propels (through traction) the one or more belts 16 that are routed around the traction sheave 52. Diverter, deflector or idler sheaves 18 are not driven by a machine 50, but help guide the one or more belts 16 around the various components of the elevator system 10. The one or more belts 16 could also be connected to a counterweight 22, which is used to help balance the elevator system 10 and reduce the difference in belt tension on both sides of the traction sheave during operation. The sheaves 18 and 52 each have a diameter, which may be the same or different from each other.

In some embodiments, the elevator system 10 could use two or more belts 16 for suspending and/or driving the elevator car 14 In addition, the elevator system 10 could have various configurations such that either both sides of the one or more belts 16 engage the sheaves 18, 52 or only one side of the one or more belts 16 engages the sheaves 18, 52. The embodiment of FIG. 1 shows a 1:1 roping arrangement in which the one or more belts 16 terminate at the car 14 and counterweight 22, while other embodiments may utilize other roping arrangements.

The belts 16 are constructed to meet belt life requirements and have smooth operation, while being sufficiently strong to be capable of meeting strength requirements for suspending and/or driving the elevator car 14 and counterweight 22.

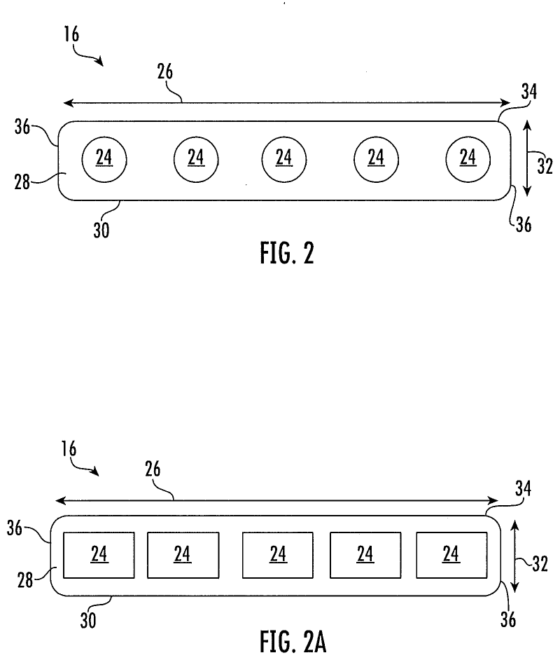

FIG. 2 provides a cross-sectional schematic of an exemplary belt 16 construction or design. The belt 16 includes a plurality of tension elements 24 extending longitudinally along the belt 16 and arranged across a belt width 26. The tension elements 24 are at least partially enclosed in a jacket 28 to restrain movement of the tension elements 24 in the belt 16 with respect to each other and to protect the tension elements 24. The jacket 28 defines a traction side 30 configured to interact with a corresponding surface of the traction sheave 52. A primary function of the jacket 28 is to provide a sufficient coefficient of friction between the belt 16 and the traction sheave 52 to produce a desired amount of traction therebetween. The jacket 28 should also transmit the traction loads to the tension elements 24. In addition, the jacket 28 should be wear resistant and protect the tension elements 24 from impact damage, exposure to environmental factors, such as chemicals, for example.

The belt 16 has a belt width 26 and a belt thickness 32, with an aspect ratio of belt width 26 to belt thickness 32 greater than one. The belt 16 further includes a back side 34 opposite the traction side 30 and belt edges 36 extending between the traction side 30 and the back side 34. While five tension members 24 are illustrated in the embodiment of FIG. 2, other embodiments may include other numbers of tension members 24, for example, 6, 10 or 12 tension elements 24. Further, while the tension elements 24 of the embodiment of FIG. 2 are substantially identical, in other embodiments, the tension elements 24 may differ from one another. While a belt 16 with a rectangular cross-section is illustrated in FIG. 2, it is to be appreciated that belts 16 having other cross-sectional shapes are contemplated within the scope of the present disclosure.

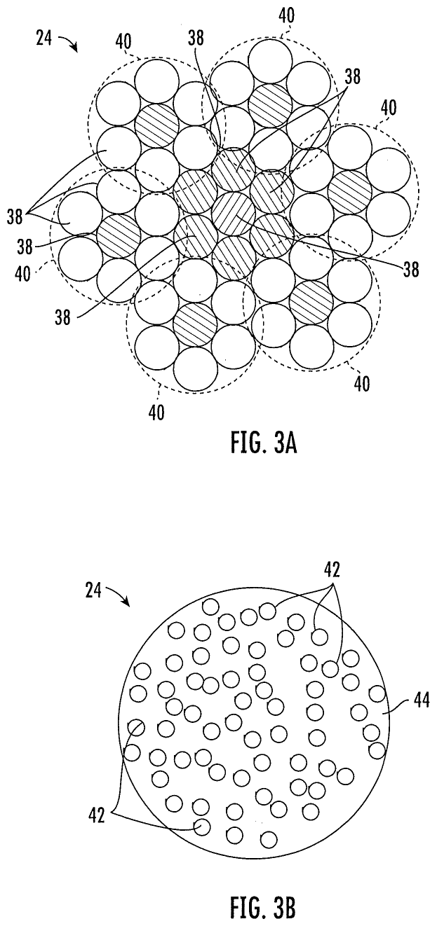

Referring now to FIG. 3A, the tension element 24 may be a plurality of wires 38, for example, steel wires 38, which in some embodiments are formed into one or more strands 40. In other embodiments, such as shown in FIG. 3B, the tension element 24 may include a plurality of fibers 42, such as carbon fiber, glass fiber aramid fiber, or their combination, disposed in a matrix material 44. Materials such as polyurethane, vinylester, or epoxy may be utilized as the matrix material, as well as other thermoset materials and, for example, thermoset polyurethane materials. While a circular cross-sectional tension element geometry is illustrated in the embodiment of FIG. 3B, other embodiments may include different tension element cross-sectional geometries, such as rectangular (shown in FIG. 2A) or ellipsoidal. While the cross-sectional geometries of the tension elements 24 in FIG. 2 are shown as identical, in other embodiment the tension elements' cross-sectional geometries may differ from one another.

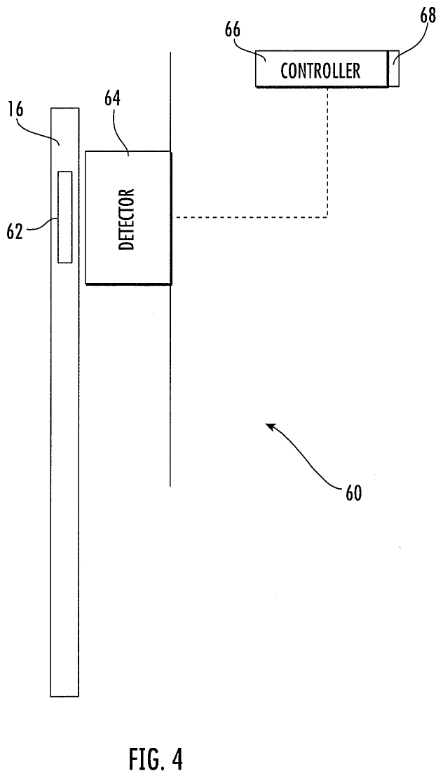

Referring now to FIG. 4, illustrated is a verification system 60 for the tension elements 24 of the belts 16, including those with steel tension elements 24 as well as those having non-metallic tension elements 24 formed, for example, from the plurality of fibers 42 suspended in a matrix material 44.

The verification system 60 includes one or more tension member identifiers 62 disposed at the belt 16. The identifier 62 is detectable and readable by a detector 64, which in some embodiments is fixed in the hoistway 12. In other embodiments, the detector 64 is not fixed in the hoistway 12, but is for example, a hand-held detector 64 used by a service technician or other personnel. Further, in some embodiments two or more detectors 64 are located in the hoistway 12 to attempt to read the identifier 62 of the belt 16. Further, in elevator system 10 having more than one belt 16, the detector 64 may be movable to periodically scan each belt 16 of the elevator system 10. The identifier 62 includes information that, when read by the detector 64, identifies the belt 16 as the correct belt 16 for a particular elevator system 10. In some embodiments, the identifier 62 is one of an RFID tag, a barcode, or other embedded element. In other embodiments, the identifier 62 may be a unique pattern or other feature formed on an exterior surface of the belt 16. The identifier 62 may include such information as belt 16 manufacturer and date and time of manufacture, and may also include belt 16 configuration information, such as details of the tension element 24 construction. The detector 64, which in some embodiments is an RFID sensor or bar code reader or the like, in configured to detect the presence of the identifier 62, and is also configured to read the information included in the identifier 62. Further, the detector 64 algorithm or protocol may be encrypted or otherwise protected to prevent unauthorized manipulation. Utilizing the detector 64 in combination with the identifier 62 monitors the belt 16 or belts 16 installed in the elevator system 10, and can identify when the correct belt 16 is utilized, and can also identify when the incorrect belt 16 is utilized. In some embodiments, the correct belt 16 is one approved by an authorized entity for utilization in the particular elevator system 10 into which the belt 16 is installed.

In some embodiments, the detector 64 is operably connected to an elevator system controller 66. The controller 66 may be connected to a memory 68 in which information regarding the correct belt 16 configuration is stored, for example, as stated above, the manufacturer and the time and date of manufacture. Other information, such as belt serial number or other configuration information may also be stored at the memory 68. In some embodiments, the memory 68 may be located at the elevator system controller 66, while in other embodiments the memory 68 is located remotely from the elevator system 10, at for example a cloud server and connected to the detector 64 via a wireless connection. Further, in other embodiments the controller 66 and the memory 68 may be located in a handheld detector 64 utilized by the service technician. When connected to the elevator system controller 66, the detector 64 transmits sensed or detected information from the identifier 62. If the detector 64 fails to detect the correct belt 16 via the identifier 62, or alternatively fails to detect an identifier 62 at an expected location of the identifier 62, the elevator system controller 66 may take action, such as the sounding of an alarm and/or slowing operation of the elevator system 10 to a slower than normal speed, such as 0.5 m/s, due to the potential safety risk of incorrect belts 16 being utilized in the elevator system 10. In some embodiments, the alarm signal may be transmitted to, for example, a remote service site or a resident building management company responsible for service and/or inspection of the elevator system 10.

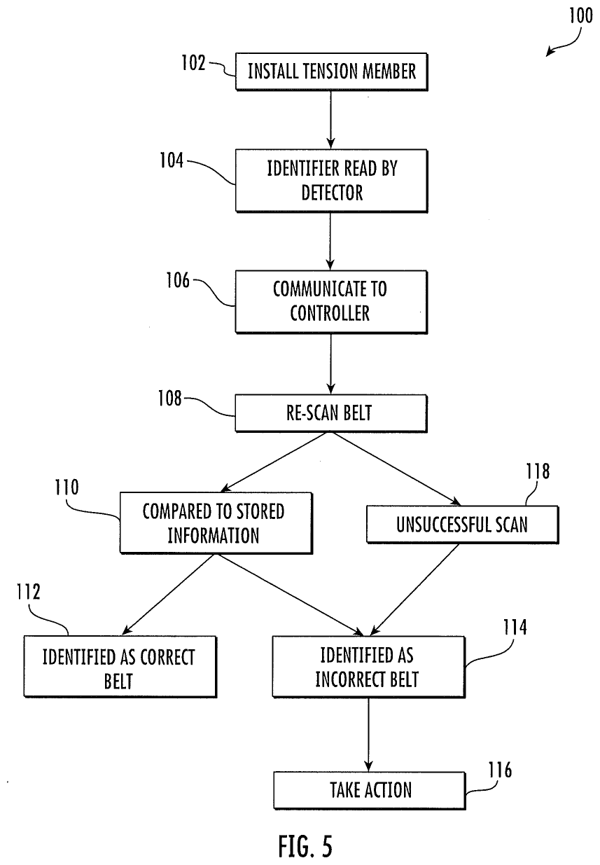

Referring now to FIG. 5, a method 100 of operating the verification system 60 of the elevator system 10 is illustrated. At block 102, the tension member, or belt 16, is installed in the hoistway 12. As stated above, the belt 16 includes one or more identifiers 62. At block 104, the identifier 62 is read by the detector 64. The reading via the detector 64 may occur before or after installation of the belt 16 in the hoistway 12. At block 106, the identifying information, such as manufacturer, date and time or manufacture, belt serial number, and/or other configuration information is communicated to the elevator system controller 66 for storage in memory 68 thereat. The storage of the information from identifier 62 at the elevator system controller 68 identifies the belt 16 as the correct belt 16 for use in the elevator system 10.

At block 108, the belt 16 is periodically re-scanned, at which time the detector 64 attempts to read the identifier 62. If the detector 64 successfully reads an identifier 62, the information from the identifier 62 is compared to the information stored at the elevator system controller 68 at block 110. If the read information matches the stored information, the belt 16 is identified as the correct belt 16 at block 112, and elevator system 10 operation continues as normal. Alternatively, if the read information does not match the stored information, the belt 16 is identified as an incorrect belt 16 at block 114. The elevator system controller 68 may then take action at block 116 to, for example, send an alarm signal and/or slow operation of the elevator system 10 to a speed significantly lower than normal. Additionally, if the detector 64 cannot successfully identify or read an identifier 62 at an expected location of the belt 16 at block 118, the belt 16 is identified as an incorrect belt 16, and the elevator system controller 68 takes action at block 116.

The verification system 60 disclosed herein reduces the likelihood of failure of the elevator system 16, by ensuring that the correct belt 16 or other tension member is installed in the elevator system 10.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A tension member verification system of an elevator system, comprising:
one or more identifier elements disposed at the tension member, the one or more identifier elements including one or more configuration parameters of the tension member;
a detector positioned and configured to verify presence of the one or more identifier elements, and configured to read the one or more configuration parameters of the tension member; and
an elevator system controller operably connected to the detector and configured to:
compare the detected one or more configuration parameters to stored configuration parameters stored at the elevator system controller; and
take one or more actions in operation of the elevator system based on the result of the comparison.

2. The tension member verification system of claim 1, wherein the one or more identifier elements are one or more of a bar code or an RFID tag.

3. The tension member verification system of claim 1, wherein the one or more configuration parameters include one or more of manufacturer, date of manufacture or time of manufacture.

4. The tension member verification system of claim 1, wherein the one or more actions include one or more of sounding an alarm or slowing operation of the elevator system to below a normal operating speed.

5. The tension member verification system of claim 1, wherein the controller is configured to take the one or more actions when a result of the comparison indicates that an incorrect tension member is installed in the elevator system.

6. The tension member verification system of claim 1, wherein the detector is fixed in a hoistway of the elevator system.

7. An elevator system, comprising:
a hoistway;
an elevator car movable along the hoistway;
one or more tension members operably connected to the elevator car to move the elevator car along the hoistway; and
a tension member verification system, including:
one or more identifier elements disposed at the tension member, the one or more identifier elements including one or more configuration parameters of the tension member;
a detector positioned and configured to verify presence of the one or more identifier elements, and configured to read the one or more configuration parameters of the tension member; and
an elevator system controller operably connected to the detector and configured to:
compare the detected one or more configuration parameters to stored configuration parameters stored at the elevator system controller; and
take one or more actions in operation of the elevator system based on the result of the comparison.

8. The elevator system of claim 7, wherein the one or more identifier elements are one or more of a bar code or an RFID tag.

9. The elevator system of claim 7, wherein the one or more configuration parameters include one or more of manufacturer, date of manufacture or time of manufacture.

10. The elevator system of claim 7, wherein the one or more actions include one or more of sounding an alarm or slowing operation of the elevator system to below a normal operating speed.

11. The elevator system of claim 7, wherein the controller is configured to take the one or more actions when a result of the comparison indicates that an incorrect tension member is installed in the elevator system.

12. The elevator system of claim 7, wherein the detector is fixed in the hoistway.

13. A method of verification of a tension member of an elevator system, comprising:
storing one or more configuration parameters of a correct tension member of an elevator system at an elevator system controller;
detecting an identifier element of an installed tension member of the elevator system via a detector;
transmitting a detected one or more configuration parameters of the installed tension member to the elevator system controller via the detector;
comparing the one or more configuration parameters of the installed tension member to the one or more configuration parameters of the correct tension member at the elevator system controller; and
taking one or more actions in operation of the elevator system via the elevator system controller based on a result of the comparison.

14. The method of claim 13, further comprising one or more of sounding an alarm or slowing operation of the elevator system to a speed below normal operating speed based on the result of the comparison.

15. The method of claim 14, wherein the operation of the elevator system is slowed to a speed of about 0.5 m/s.

16. The method of claim 13, wherein the result of the comparison indicates that an incorrect tension member is installed in the elevator system.

17. The method of claim 13, wherein the one or more identifier elements are one or more of a bar code or an RFID tag.

18. The method of claim 13, wherein the one or more configuration parameters include one or more of manufacturer, date of manufacture or time of manufacture.

20. The method of claim 13, wherein the detector is fixed in the hoistway.
